(19) United States
(12) Patent Application Publication
(10) Pub. No.: US 2026/0331815 A1
(43) Pub. Date: Oct. 22, 2026

(54) HINGE, CONNECTOR HOUSING ASSEMBLY, CONNECTOR AND CONNECTOR PRODUCT

(71) Applicant: Tyco Electronics (Shanghai) Co., Ltd., Shanghai (CN)

(72) Inventors: Tommy Qian, Shanghai (CN); Xiao (Nichee) Zhou, Shanghai (CN); Yuchen Yang, Shanghai (CN); Xinquan (Jone) Ji, Shanghai (CN)

(73) Assignee: Tyco Electronics (Shanghai) Co., Ltd., Shanghai (CN)

(21) Appl. No.: 19/654,704

(22) Filed: Apr. 22, 2026

(30) Foreign Application Priority Data
Apr. 22, 2025 (CN) 202510510575.6

(51) Int. Cl. H01R 13/447; H01R 13/10; H01R 13/502; H01R 13/621

(52) U.S. Cl. CPC H01R 13/447; H01R 13/10; H01R 13/502; H01R 13/621

(57) ABSTRACT

A connector housing assembly includes a housing and a top cover. The housing has an installation port formed at a top of the housing. The top cover is rotatably installed on the top of the housing. A first hinge structure is formed on the housing, and a second hinge structure rotatably engaged with the first hinge structure is formed on the top cover such that the top cover is rotatable relative to the housing between an open position that opens the installation port and a closed position that closes the installation port. The first hinge structure has a V-shaped slot and an arc-shaped cantilever. The second hinge structure has a flat pivot shaft and a slot hole. The flat pivot shaft is rotatably mated with the V-shaped slot. The arc-shaped cantilever passes through the slot hole and has an arc-shaped guide part guiding a rotation of the top cover.

### CROSS-REFERENCE TO RELATED APPLICATION

This application claims the benefit of the filing date under 35 U.S.C. § 119(a)-(d) of Chinese Patent Application No. CN202510510575.6 filed on Apr. 22, 2025, the whole disclosure of which is incorporated herein by reference.

### FIELD OF THE INVENTION

The present invention relates to a connector housing assembly and, more particularly, to a connector housing assembly with a hinge structure and a connector comprising the connector housing assembly. In addition, the present invention also relates to a hinge, a connector housing assembly comprising the hinge, and a connector comprising the connector housing assembly. In addition, the present invention also relates to a hinge and a connector product comprising the hinge.

### BACKGROUND OF THE INVENTION

A high-voltage connector typically includes a housing, a top cover, a conductive bar, a terminal, and a threaded connection member. The terminal is soldered to the front end of the conductive bar, and the front end of the conductive bar is inserted into the housing. An installation port is formed at the top of the housing. The threaded connection member enters the housing through the installation port, passes through the conductive bar and the terminal, and is used to fasten the terminal to a mating terminal of a mating connector. The top cover is rotatably installed on the top of the housing for opening and closing the installation port of the housing. Typically, the top cover is rotatably installed on the top of the housing through a hinge structure, but the installation force of the existing hinge structure is relatively high, making installation very difficult.

### SUMMARY OF THE INVENTION

A connector housing assembly includes a housing and a top cover. The housing has an installation port formed at a top of the housing. The top cover is rotatably installed on the top of the housing. A first hinge structure is formed on the housing, and a second hinge structure rotatably engaged with the first hinge structure is formed on the top cover such that the top cover is rotatable relative to the housing between an open position that opens the installation port and a closed position that closes the installation port. The first hinge structure has a V-shaped slot and an arc-shaped cantilever. The second hinge structure has a flat pivot shaft and a slot hole. The flat pivot shaft is rotatably mated with the V-shaped slot. The arc-shaped cantilever passes through the slot hole and has an arc-shaped guide part guiding a rotation of the top cover.

### BRIEF DESCRIPTION OF DRAWINGS

The invention will now be described by way of example with reference to the accompanying figures, of which:

FIG. 1 is an exploded view of a connector according to an exemplary embodiment;

FIG. 2 is an exploded sectional view of the connector of FIG. 1;

FIG. 3 is a perspective view of a top cover of the connector of FIG. 1;

FIG. 4 is a cross-sectional view of the connector of FIG. 1, with the top cover of FIG. 3 in an open position;

FIG. 5 is a cross-sectional view of the connector of FIG. 1, with the top cover of FIG. 3 in a closed position;

FIG. 6 is an exploded view of a hinge according to an exemplary embodiment;

FIG. 7 is a perspective view of the hinge of FIG. 6, where the hinge is in a vertical position;

FIG. 8 is a perspective view of the hinge of FIG. 6, where the hinge is in a horizontal position;

FIG. 9 is an exploded view of a connector housing assembly according to an exemplary embodiment;

FIG. 10 is a perspective view of the connector housing assembly of FIG. 9, with a top cover in an open position;

FIG. 11 is a perspective view of the connector housing assembly of FIG. 9, with the top cover of FIG. 10 in a closed position;

FIG. 12 is an exploded view of a connector housing assembly according to another exemplary embodiment;

FIG. 13 is a perspective view of the connector housing assembly of FIG. 12, with a top cover in an open position;

FIG. 14 is a perspective view of the connector housing assembly of FIG. 12, with the top cover of FIG. 13 in a closed position; and

FIG. 15 is an exploded view of a hinge according to another exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

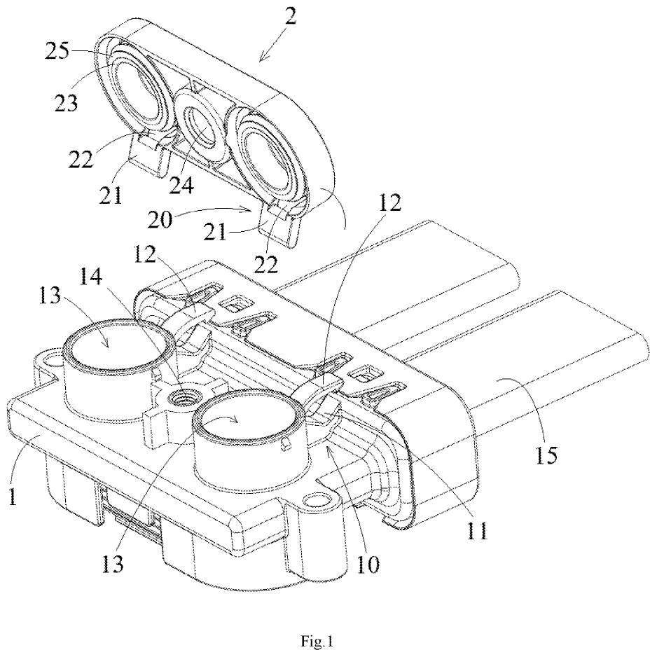

An exemplary embodiment of a connector housing assembly will now be described with reference to FIGS. 1-5. As shown in FIG. 1, the connector housing assembly includes a housing 1 and a top cover 2. Each of the housing 1 and the top cover 2 is an integral injection molded part. This can improve manufacturing efficiency and reduce manufacturing costs.

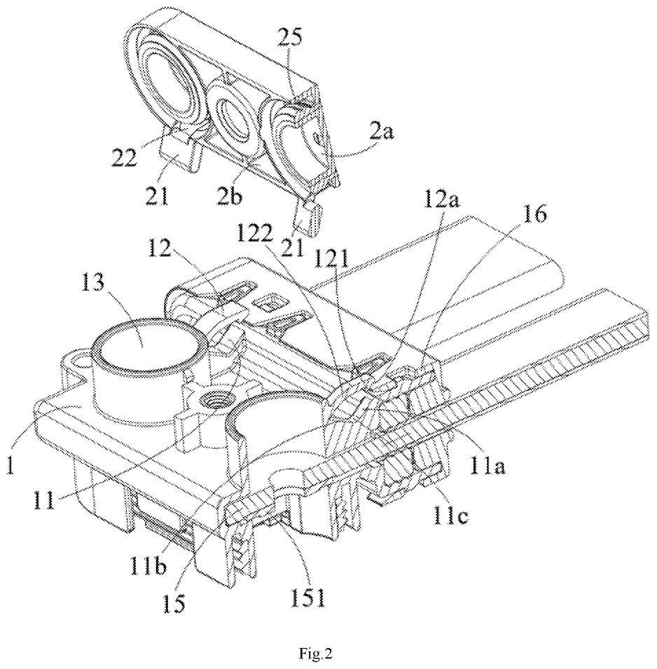

An installation port 13, as shown in FIGS. 1-2, is formed at the top of the housing 1. The top cover 2 is rotatably installed on the top of the housing 1. A first hinge structure 10 is formed on the housing 1, as shown in FIG. 1, and a second hinge structure 20, as shown in FIG. 1, that is rotatably engaged with the first hinge structure 10 is formed on the top cover 2, so that the top cover 2 can be rotated relative to the housing 1 between an open position of opening the installation port 13 and a closed position of closing the installation port 13. As shown in FIGS. 1-2, the first hinge structure 10 includes a V-shaped slot 11 and an arc-shaped cantilever 12, while the second hinge structure 20 includes a flat pivot shaft 21 and a slot hole 22. The flat pivot shaft 21 is rotatably mated with the V-shaped slot 11, and the arc-shaped cantilever 12 passes through the slot hole 22 and has an arc-shaped guide part 122 for guiding the rotation of the top cover 2.

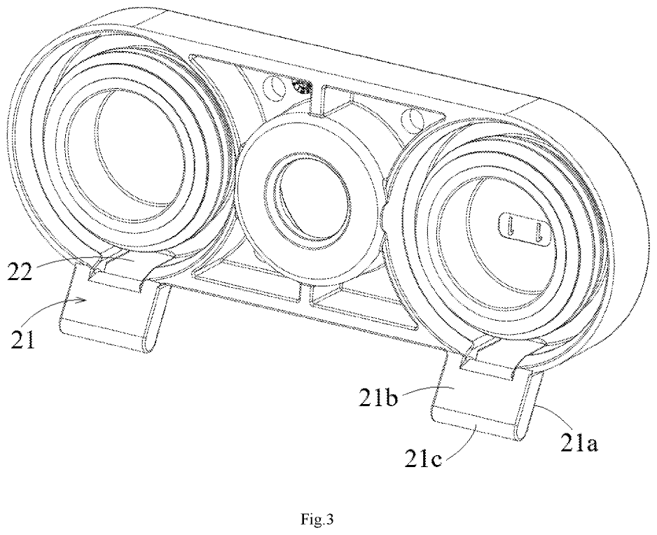

The V-shaped slot 11 has a first inclined inner side surface 11a and a second inclined inner side surface 11b, as shown in FIG. 2, and the flat pivot shaft 21 has two opposing surfaces 21a, 21b, as shown in FIG. 3, in its thickness. During the installation of the top cover 2, one surface 11a of the flat pivot shaft 21 is pressed against the first inclined inner side surface 11a, and the flat pivot shaft 21 is slidably inserted into the V-shaped slot 11 in a direction parallel to the first inclined inner side surface 11a.

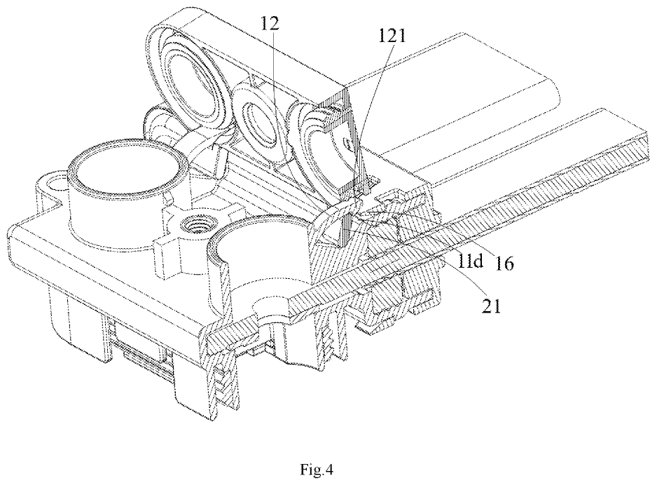

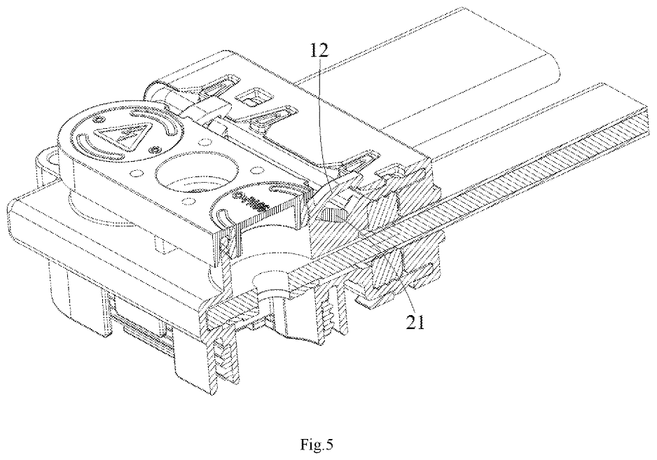

When the top cover 2 is rotated to the closed position, as shown in FIG. 5, the other surface 11b of the flat pivot shaft 21 is pressed against the second inclined inner side surface 11b of the V-shaped slot 11. When the top cover 2 is rotated to the open position, as shown in FIG. 4, the two surfaces 21a, 21b of the flat pivot shaft 21 are not in contact with the first inclined inner side surface 11a and the second inclined inner side surface 11b, and the arc-shaped side surface 21c of the flat pivot shaft 21 is in contact with the arc-shaped bottom surface 11c of the V-shaped slot 11.

As shown in FIGS. 2 and 4, a hook 121 is formed at the end of the arc-shaped cantilever 12 which engages with the slot hole 22 when the top cover 2 is rotated to the open position to keep the top cover 2 in the open position and prevent it from being detached from the housing 1.

As shown in FIG. 2, the hook 121 has an inclined guide surface 12a. The inclined guide surface 12a of the hook 121 is spaced apart from and parallel to the first inclined inner side surface 11a of the V-shaped slot 11. When installing the top cover 2, the two surfaces 21a, 21b of the flat pivot shaft 21 are respectively pressed against the first inclined inner side surface 11a and the inclined guide surface 12a, and the flat pivot shaft 21 is slidably inserted into the V-shaped slot 11 in a direction parallel to the first inclined inner side surface 11a.

As shown in FIGS. 2 and 4, the connector housing assembly further includes an end cap 16, which is fitted and locked onto the rear end of the housing 1. When the end cap 16 is assembled onto the housing 1, a part of the end cap 16 is located in an entrance 11d between the first inclined inner side surface 11a and the inclined guide surface 12a, to block the flat pivot shaft 21 and prevent it from being detached from the entrance 11d.

As shown in FIG. 2, the top cover 2 has a cover plate 2a and a peripheral wall 2b. The slot hole 22 is formed in the peripheral wall 2b of the top cover 2, and the flat pivot shaft 21 is connected to the front side of the peripheral wall 2b of the top cover 2.

As shown in FIGS. 1-2, the top cover 2 also has a cylindrical part 23 formed on the inner side of the cover plate 2a, and the connector housing assembly further includes a sealing ring 25 provided on the outer side of the cylindrical part 23. When the top cover 2 is rotated to the closed position, the cylindrical part 23 and the sealing ring 25 are inserted into the installation port 13 of the housing 1, and the sealing ring 25 is radially compressed between the inner peripheral surface of the installation port 13 and the outer peripheral surface of the cylindrical part 23 to achieve sealing between the two.

As shown in FIGS. 1-2, multiple installation ports 13 are formed at the top of the housing 1, and the top cover 2 has multiple cylindrical parts 23 corresponding to the multiple installation ports 13. The connector housing assembly includes multiple sealing rings 25 respectively arranged on the outer sides of the multiple cylindrical parts 23 for sealing the multiple installation ports 13.

As shown in FIG. 1, a threaded hole 14 suitable for connecting with a bolt is formed in the top of the housing 1, and a connection hole 24 allowing the bolt to pass through is formed in the top cover 2. When the top cover 2 is rotated to the closed position, it is adapted to be fastened to the top of the housing 1 by a bolt passing through the connection hole 24 and connected to the threaded hole 14.

An exemplary embodiment of a connector will now be described with reference to FIGS. 1-5. The connector includes the connector housing assembly, a conductive bar 15, as shown in FIGS. 1-2, a terminal 151, as shown in FIG. 2, and a threaded connection member. The conductive bar 15 extends into the housing 1 from the rear port of the housing 1. The terminal 151 is ring-shaped and soldered to the front end of the conductive bar 15. The threaded connection member enters the housing 1 from the installation port 13 of the housing 1. The threaded connection member passes through the conductive bar 15 and the terminal 151, and is used to fasten the terminal 151 to a mating terminal of a mating connector.

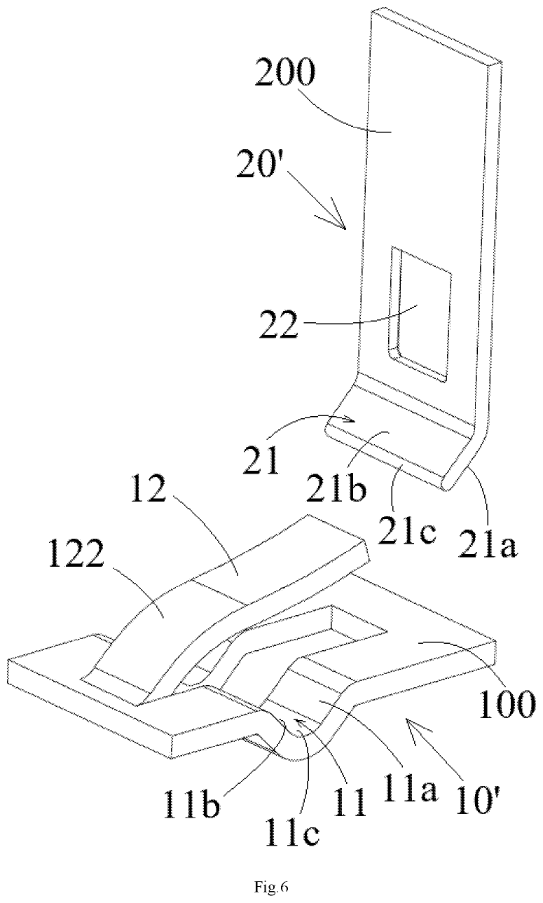

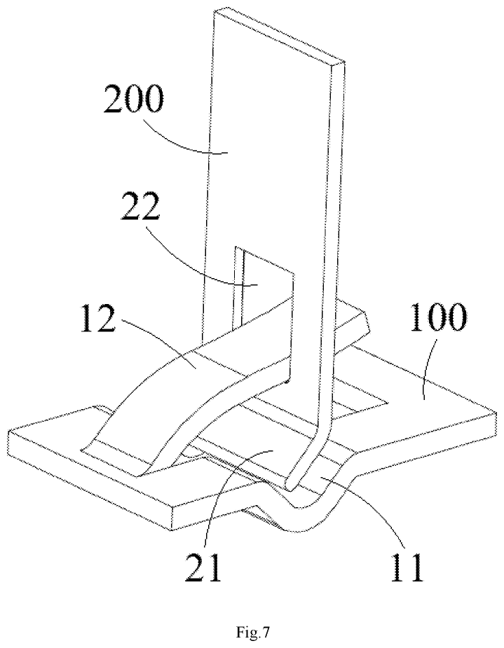

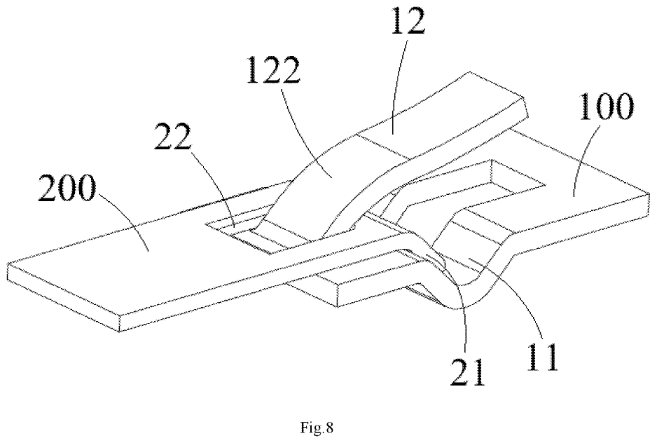

An exemplary embodiment of a hinge will now be described with reference to FIGS. 6-8. As shown in FIG. 6, the hinge includes a first hinge component 10′ and a second hinge component 20′. Each of the first hinge component 10′ and the second hinge component 20′ is an integral metal stamped part.

As shown in FIGS. 6-8, the first hinge component 10′ includes a first plate part 100 and an arc-shaped cantilever 12. The second hinge component 20′, as shown in FIGS. 6-8, includes a second plate part 200 and a flat pivot shaft 21. The first plate part 100 is formed with a V-shaped slot 11, as shown in FIGS. 6-8. The arc-shaped cantilever 12 is connected to one end of the first plate part 100. As shown in FIGS. 6-8, the second plate part 200 is formed with a slot hole 22. The flat pivot shaft 21 is connected to one end of the second plate part 200. The flat pivot shaft 21 is rotatably mated with the V-shaped slot 11, and the arc-shaped cantilever 12 passes through the slot hole 22 and has an arc-shaped guide part 122 for guiding one of the first hinge component 10′ and the second hinge component 20′ to rotate relative to the other.

As shown in FIG. 6, the V-shaped slot 11 has a first inclined inner side surface 11a and a second inclined inner side surface 11b, and the flat pivot shaft 21 has two opposing surfaces 21a, 21b in its thickness. During the installation of the hinge, one surface 21a of the flat pivot shaft 21 is pressed against the first inclined inner side surface 11a, and the flat pivot shaft 21 is slidably inserted into the V-shaped slot 11 in a direction parallel to the first inclined inner side surface 11a.

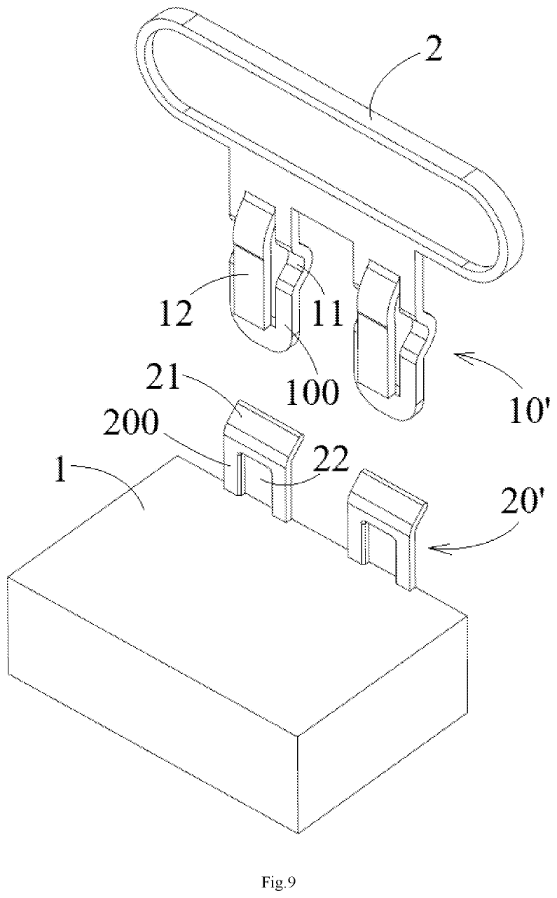

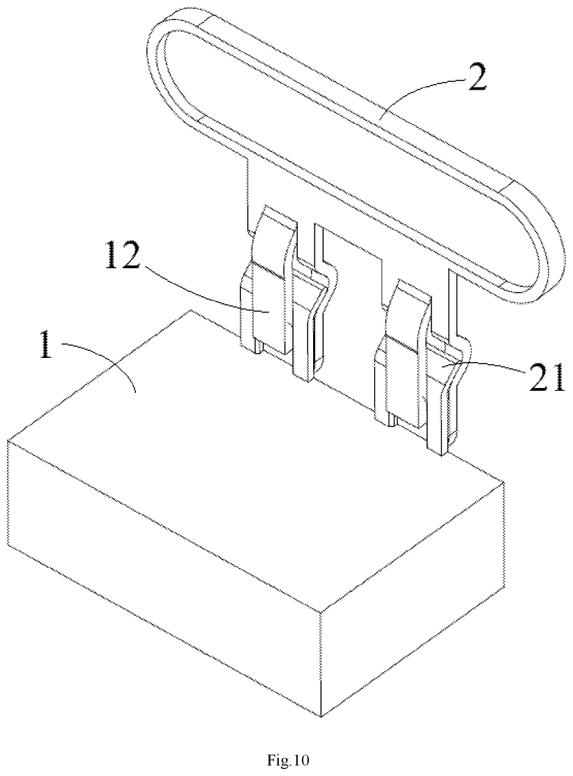

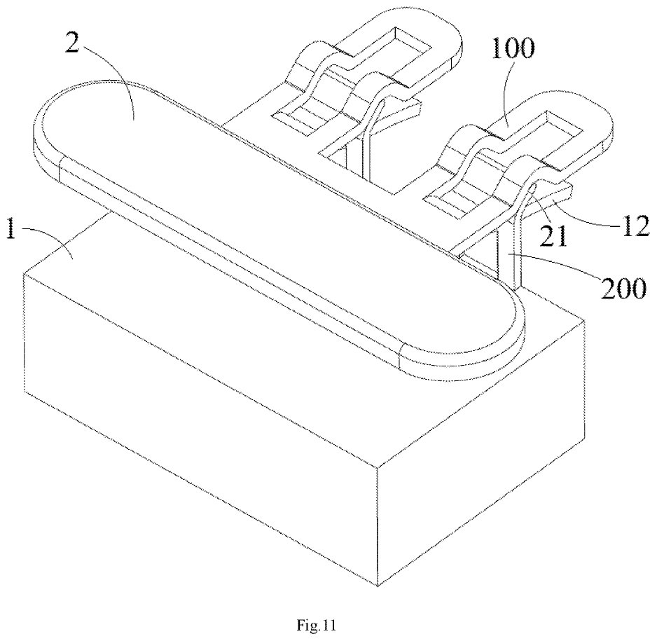

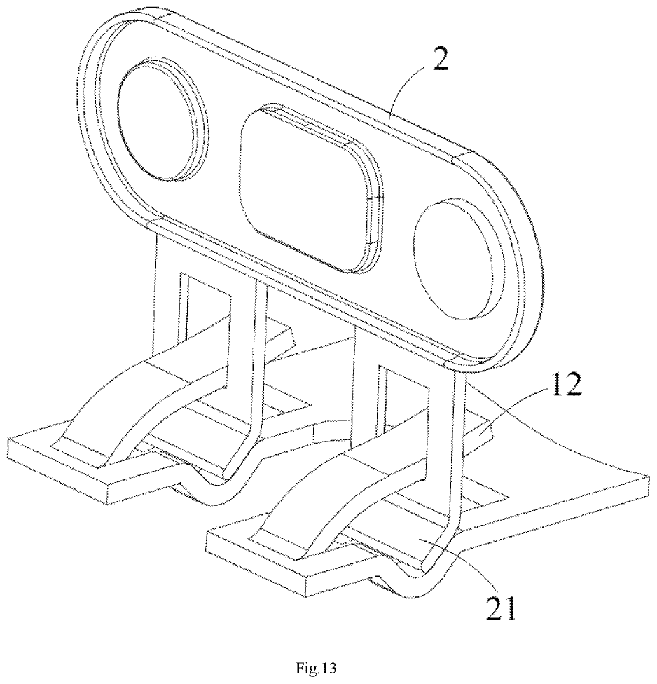

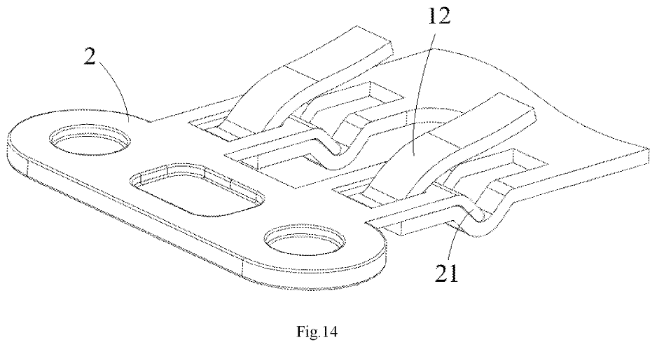

Another exemplary embodiment of a connector housing assembly will now be described with reference to FIGS. 6-14. As shown in FIG. 9, the connector housing assembly includes the aforementioned hinge, a housing 1, and a top cover 2. A installation port 13 is formed at the top of the housing 1. The top cover 2 is rotatably mounted to the top of the housing 1 through the hinge. One of the first hinge component 10′ and the second hinge component 20′ is fixed to the housing 1, and the other is fixed to the top cover 2 or integrally formed with the top cover 2, so that the top cover 2 can be rotated relative to the housing 1 through the hinge between an open position of opening the installation port 13 and a closed position of closing the installation port 13.

As shown in FIG. 9, the first plate part 100 of the first hinge component 10′ is fixed to the top cover 2 or integrally formed with the top cover 2, and the second plate part 200 of the second hinge component 20′ is fixed to the housing 1.

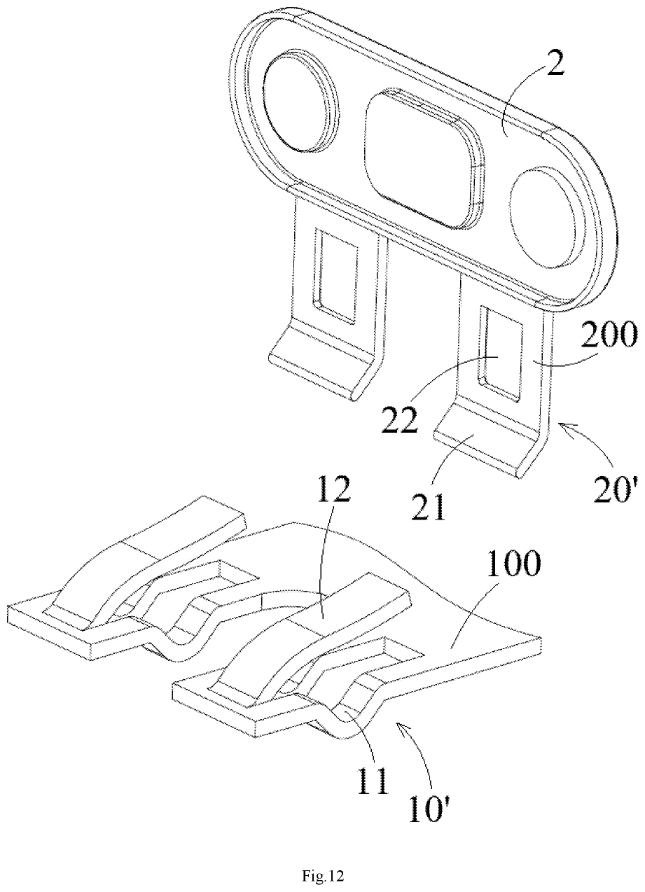

The first plate part 100 of the first hinge component 10′ is fixed to the housing 1, and the second plate part 200 of the second hinge component 20′, as shown in FIG. 12, is fixed to the top cover 2 or integrally formed with the top cover 2.

One of the first hinge component 10′ and the second hinge component 20′ is an integral metal stamped part, and the housing 1 is an integral injection molded part. The other of the first hinge component 10′ and the second hinge component 20′ is a metal component that is integrally formed with the top cover 2.

An exemplary embodiment of a connector will now be described with reference to FIGS. 6-14. The connector includes the aforementioned connector housing assembly, a conductive bar 15, a terminal 151, and a threaded connection member. The conductive bar 15 extends into the housing 1 from the rear port of the housing 1. The terminal 151 is ring-shaped and soldered to the front end of the conductive bar 15. The threaded connection member enters the housing 1 from the installation port 13 of the housing 1. The threaded connection member passes through the conductive bar 15 and the terminal 151, used to fasten the terminal 151 to a mating terminal of a mating connector.

An exemplary embodiment of a connector product will now be described with reference to FIGS. 6-14. The connector product includes the aforementioned hinge, a first component (e.g. the housing 1), and a second component (e.g. the top cover 2). The second component is rotatably mounted onto the first component through the hinge. One of the first hinge component 10′ and the second hinge component 20′ is fixed to the first component or integrally formed with the first component, and the other is fixed to the second component or integrally formed with the second component, so that one of the first component and the second component can be rotated relative to the other through the hinge.

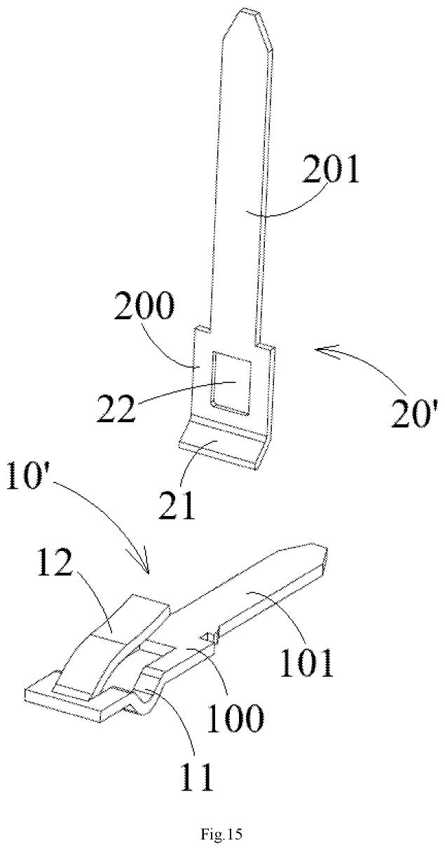

Another exemplary embodiment of a hinge will now be described with reference to FIG. 15. As shown in FIG. 15, the first hinge component 10′ comprises a first needle shaped part 101 connected to the other end of the first plate part 100, and the second hinge component 20′ comprises a second needle shaped part 201 connected to the other end of the second plate part 200. One of the first needle shaped part 101 and the second needle shaped part 201 is used to fix to the first component, and the other is used to fix to the second component. For example, insertion slots are formed on the first and second components, and the first needle shaped part 101 and the second needle shaped part 201 can be inserted into the insertion slots.

In the aforementioned exemplary embodiments according to the present invention, the installation force of the hinge structure is relatively small, making installation very convenient. In addition, the arc-shaped cantilever 12 of the hinge structure is longer, which not only reduces the installation force of the hinge structure, but also guides the top cover 2 to rotate smoothly along the arc-shaped cantilever 12. Additionally, the end cap 16 can prevent the hinge structure from detaching, thereby improving the reliability of use. Further, the metal hinge can be used to further enhance the elasticity of the arc-shaped cantilever 12.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector housing assembly, comprising:
a housing having an installation port formed at a top of the housing; and
a top cover rotatably installed on the top of the housing, a first hinge structure is formed on the housing, and a second hinge structure rotatably engaged with the first hinge structure is formed on the top cover such that the top cover is rotatable relative to the housing between an open position that opens the installation port and a closed position that closes the installation port, the first hinge structure has a V-shaped slot and an arc-shaped cantilever, and the second hinge structure has a flat pivot shaft and a slot hole, the flat pivot shaft is rotatably mated with the V-shaped slot, the arc-shaped cantilever passes through the slot hole and has an arc-shaped guide part guiding a rotation of the top cover.

2. The connector housing assembly of claim 1, wherein the V-shaped slot has a first inclined inner side surface and a second inclined inner side surface, the flat pivot shaft has two opposite surfaces in a thickness of the flat pivot shaft, when installing the top cover, one surface of the flat pivot shaft is pressed against the first inclined inner side surface, and the flat pivot shaft is slidably inserted into the V-shaped slot in a direction parallel to the first inclined inner side surface.

3. The connector housing assembly of claim 2, wherein when the top cover is rotated to the closed position, an other surface of the flat pivot shaft is pressed against the second inclined inner side surface of the V-shaped slot, and when the top cover is rotated to the open position, the two surfaces of the flat pivot shaft are not in contact with the first inclined inner side surface and the second inclined inner side surface, and an arc-shaped side surface of the flat pivot shaft contacts an arc-shaped bottom surface of the V-shaped slot.

4. The connector housing assembly of claim 2, wherein a hook is formed at an end of the arc-shaped cantilever, the hook engages with the slot hole when the top cover is rotated to the open position to keep the top cover in the open position and prevent the top cover from being detached from the housing.

5. The connector housing assembly of claim 4, wherein the hook has an inclined guide surface, the inclined guide surface is spaced apart from and parallel to the first inclined inner side surface, when installing the top cover, the two surfaces of the flat pivot shaft are respectively pressed against the first inclined inner side surface and the inclined guide surface, the flat pivot shaft is slidably inserted into the V-shaped slot in the direction parallel to the first inclined inner side surface.

6. The connector housing assembly of claim 5, further comprising an end cap fitted and locked onto a rear end of the housing, when the end cap is assembled onto the housing, a part of the end cap is located in an entrance between the first inclined inner side surface and the inclined guide surface to block the flat pivot shaft and prevent the flat pivot shaft from being detached from the entrance.

7. The connector housing assembly of claim 1, wherein the top cover has a cover plate and a peripheral wall, the slot hole is formed in the peripheral wall of the top cover, the flat pivot shaft is connected to the front side of the peripheral wall of the top cover.

8. The connector housing assembly of claim 7, wherein the top cover has a cylindrical part formed on an inner side of the cover plate, and the connector housing assembly further comprises a sealing ring arranged on an outer side of the cylindrical part, when the top cover is rotated to the closed position, the cylindrical part and the sealing ring are inserted into the installation port of the housing and the sealing ring is radially compressed between an inner peripheral surface of the installation port and an outer peripheral surface of the cylindrical part to achieve sealing between the two.

9. The connector housing assembly of claim 8, wherein a plurality of installation ports are formed at the top of the housing, and the top cover has a plurality of cylindrical parts corresponding to the installation ports, the connector housing assembly includes a plurality of sealing rings respectively arranged on outer sides of the cylindrical parts for sealing the installation ports.

10. The connector housing assembly of claim 1, wherein a threaded hole suitable for connecting with a bolt is formed in the top of the housing, and a connection hole is formed in the top cover, when the top cover is rotated to the closed position, the top cover is fastened to the top of the housing by the bolt passing through the connection hole and connecting to the threaded hole.

11. The connector housing assembly of claim 1, wherein each of the housing and the top cover are an integral injection molded part.

12. A connector, comprising:
a connector housing assembly includes a housing having an installation port formed at a top of the housing, and a top cover rotatably installed on the top of the housing, a first hinge structure is formed on the housing, and a second hinge structure rotatably engaged with the first hinge structure is formed on the top cover such that the top cover is rotatable relative to the housing between an open position that opens the installation port and a closed position that closes the installation port, the first hinge structure has a V-shaped slot and an arc-shaped cantilever, and the second hinge structure has a flat pivot shaft and a slot hole, the flat pivot shaft is rotatably mated with the V-shaped slot, the arc-shaped cantilever passes through the slot hole and has an arc-shaped guide part guiding a rotation of the top cover;
a conductive bar extending into the housing from a rear port of the housing;
a terminal having a ring shape and welded to a front end of the conductive bar; and
a threaded connection member entering the housing from the installation port of the housing, the threaded connection member passes through the conductive bar and the terminal and fastens the terminal to a mating terminal of a mating connector.

13. A hinge, comprising:
a first hinge component including a first plate part which is formed with a V-shaped slot and an arc-shaped cantilever connected to one end of the first plate part; and
a second hinge component including a second plate part formed with a slot hole and a flat pivot shaft connected to one end of the second plate part, the flat pivot shaft is rotatably mated with the V-shaped slot, and the arc-shaped cantilever passes through the slot hole and has an arc-shaped guide part for guiding one of the first hinge component and the second hinge component to rotate relative to the other.

14. The hinge of claim 13, wherein the V-shaped slot has a first inclined inner side surface and a second inclined inner side surface, and the flat pivot shaft has two opposite surfaces in a thickness of the flat pivot shaft, when installing the hinge, one surface of the flat pivot shaft is pressed against the first inclined inner side surface, and the flat pivot shaft is slidably inserted into the V-shaped slot in a direction parallel to the first inclined inner side surface.

15. The hinge of claim 13, wherein each of the first hinge component and the second hinge component are an integral metal stamped part.

16. A connector housing assembly, comprising:
a hinge including a first hinge component and a second hinge component, the first hinge component includes a first plate part which is formed with a V-shaped slot and an arc-shaped cantilever connected to one end of the first plate part, the second hinge component includes a second plate part formed with a slot hole and a flat pivot shaft connected to one end of the second plate part, the flat pivot shaft is rotatably mated with the V-shaped slot, and the arc-shaped cantilever passes through the slot hole and has an arc-shaped guide part for guiding one of the first hinge component and the second hinge component to rotate relative to the other;
a housing having an installation port formed at a top of the housing; and
a top cover rotatably mounted on the top of the housing through the hinge, one of the first hinge component and the second hinge component is fixed to the housing, and the other of the first hinge component and the second hinge component is fixed to the top cover or integrally formed with the top cover such that the top cover is rotatable relative to the housing through the hinge between an open position of opening the installation port and a closed position of closing the installation port.

17. The connector housing assembly of claim 16, wherein:
the first plate part of the first hinge component is fixed to the housing, and the second plate part of the second hinge component is fixed to the top cover or integrally formed with the top cover; or
the first plate part of the first hinge component is fixed to the top cover or integrally formed with the top cover, and the second plate part of the second hinge component is fixed to the housing.

18. The connector housing assembly of claim 16, wherein one of the first hinge component and the second hinge component is an integral metal stamped part, and the housing is an integral injection molded part.

19. The connector housing assembly of claim 16, wherein the other of the first hinge component and the second hinge component and the top cover are formed into an integral metal component.

20. A connector, comprising:
a connector housing assembly including a hinge, a housing, and a top cover, the hinge includes a first hinge component and a second hinge component, the first hinge component includes a first plate part which is formed with a V-shaped slot and an arc-shaped cantilever connected to one end of the first plate part; the second hinge component includes a second plate part formed with a slot hole and a flat pivot shaft connected to one end of the second plate part, the flat pivot shaft is rotatably mated with the V-shaped slot, and the arc-shaped cantilever passes through the slot hole and has an arc-shaped guide part for guiding one of the first hinge component and the second hinge component to rotate relative to the other, the housing has an installation port formed at a top of the housing, the top cover rotatably mounted on the top of the housing through the hinge, one of the first hinge component and the second hinge component is fixed to the housing, and the other of the first hinge component and the second hinge component is fixed to the top cover or integrally formed with the top cover such that the top cover is rotatable relative to the housing through the hinge between an open position of opening the installation port and a closed position of closing the installation port;
a conductive bar extending into the housing from a rear port of the housing;
a terminal having a ring shape and welded to a front end of the conductive bar; and
a threaded connection member entering the housing from the installation port of the housing, the threaded connection member passes through the conductive bar and the terminal and fastens the terminal to a mating terminal of a mating connector.

21. A connector product, comprising:
a hinge including a first hinge component and a second hinge component, the first hinge component includes a first plate part which is formed with a V-shaped slot and an arc-shaped cantilever connected to one end of the first plate part, the second hinge component includes a second plate part formed with a slot hole and a flat pivot shaft connected to one end of the second plate part, the flat pivot shaft is rotatably mated with the V-shaped slot, and the arc-shaped cantilever passes through the slot hole and has an arc-shaped guide part for guiding one of the first hinge component and the second hinge component to rotate relative to the other;
a first component; and
a second component rotatably mounted to the first component through the hinge, one of the first hinge component and the second hinge component is fixed to the first component or integrally formed with the first component, and the other of the first hinge component and the second hinge component is fixed to the second component or integrally formed with the second component such that one of the first component and the second component can be rotated relative to the other through the hinge.

22. The connector product of claim 21, wherein the first hinge component includes a first needle shaped part connected to an other end of the first plate part, and the second hinge component includes a second needle shaped part connected to an other end of the second plate part, one of the first needle shaped part and the second needle shaped part fixes to the first component, and the other of the first needle shaped part and the second needle shaped part fixes to the second component.
